(19) United States
(12) Patent Application Publication
(10) Pub. No.: US 2013/0229443 A1
(43) Pub. Date: Sep. 5, 2013

(54) IMAGE PROCESSING DEVICE AND METHOD, AND PROGRAM

(71) Applicant: SONY CORPORATION, Tokyo (JP)

(72) Inventor: Yoshihiko KUROKI, Kanagawa (JP)

(73) Assignee: SONY CORPORATION, Tokyo (JP)

(21) Appl. No.: 13/741,589

(22) Filed: Jan. 15, 2013

(30) Foreign Application Priority Data
Mar. 1, 2012 (JP) 2012045469

(51) Int. Cl. G09G 3/22

(52) U.S. Cl. CPC G09G 3/22
USPC 345/690

(57) ABSTRACT

There is provided an image processing device including a gamma value calculation unit that calculates a gamma value for a pixel of an input image based on a grayscale value of the pixel, the gamma value being varied depending on the grayscale value, and an image generation unit that performs grayscale correction on the input image by raising the grayscale value of the pixel of the input image to a power of the gamma value, the grayscale value being normalized.

### BACKGROUND

The present technology relates to image processing devices, image processing methods, and programs, and in particular, to an image processing device, an image processing method, and a program, capable of presenting a high quality image in a simple way while preventing an increase in the amount of data.

In the related art, in a digital image, there is an occurrence of image deterioration in which contour lines appear in a state where luminance variation from one grayscale to another in the image is visually discriminated. In order to prevent such image deteriorations, the grayscale value of an image has been discussed in consideration of a discrimination threshold, that is, the minimum value at which a change in brightness can be perceived.

However, the discrimination threshold of the human eye is very small at a low luminance, and specifically, for example, the discrimination threshold ΔL at the brightness L=1.0 td (retinal illuminance≅0 05 cd/m²) in a dark environment that may be present in daily life is said to be in the order of ΔL=0.3 td (≅0.015 cd/m²).

If the maximum luminance 450 cd/m² which is generally desired for a display device such as a television receiver or a projector is to be uniformly quantized, then 30000 grayscale levels, that is, a bit length of 15 bits is necessary due to the discrimination threshold, and thus the data amount will increase accordingly.

Therefore, an image data process which uses a method generally called a gamma method is performed by finely quantizing a low luminance range and by roughly quantizing a high luminance range in order to reduce a data amount of image data. In the gamma method, the relationship between a grayscale value and luminance value of an image does not linearly vary, but a value obtained by normalizing a grayscale value is raised to the power of gamma, and a value obtained by multiplying the value obtained as a result thereof by the maximum luminance is set as a luminance value.

In addition, a display device has been proposed in which a plurality of color filters are provided on a color disk, a predetermined bit number of image data is displayed using predetermined color filters, and the remaining bit number of the image data is displayed using the other color filters (refer to Japanese Unexamined Patent Application Publication No. 2000-276063).

### SUMMARY

However, in the above-described related art, it is not possible to present a high quality image in a simple way while preventing an increase in the amount of data.

For example, in a typical consumer video device, there are many cases where 8-bit or 10-bit grayscale is used and gamma γ is set to 2.2, and, in a digital cinema which desires a higher quality image, 12-bit grayscale is used and gamma γ is set to 2.6.

However, a grayscale value of the digital cinema is set assuming that the maximum screen luminance in the movie theater environment is 48 cd/m² (14 fL), and thus the maximum luminance desired for a display device placed in a living room of the home is expected to reach 450 cd/m² as described above. For this reason, a bit length of grayscale in household video apparatuses is currently insufficient.

In addition, in the method in which a plurality of color filters are provided on a color disk, a process or configuration for displaying images is complicated.

The present technology is made in consideration of these circumstances, and is intended to present a high quality image in a simple way while preventing an increase in the amount of data.

According to an embodiment of the present disclosure, there is provided an image processing device including a gamma value calculation unit that calculates a gamma value for a pixel of an input image based on a grayscale value of the pixel, the gamma value being varied depending on the grayscale value, and an image generation unit that performs grayscale correction on the input image by raising the grayscale value of the pixel of the input image to a power of the gamma value, the grayscale value being normalized.

The gamma value may be varied from a first value to a second value in proportion to the grayscale value, the second value being greater than to the first value.

The gamma value calculation unit may calculate the gamma value by calculating γₘᵢₙ+(CV/(2ⁿ−1))×(γₘₐₓ−γₘᵢₙ), where n represents a grayscale bit depth of the pixel of the input image after the grayscale correction is performed, CV represents the grayscale value of the pixel, γₘₘ represents the first value, and γₘₐₓ represents the second value.

When the bit depth n is 12, the first value γₘᵢₙ may be any value between 2.8 and 4.3, and the second value γₘₐₓ may be any value between 4.7 and 7.0.

The image generation unit may calculate a pixel value of the pixel of the input image after the grayscale correction is performed by calculating Max_L×(CV/(2ⁿ−1))^{γ}, where Max_L represents a maximum value of the pixel value of the pixel of the input image after the grayscale correction is performed, and γ represents the gamma value.

According to an embodiment of the present disclosure, there is provided an image processing method or a program including calculating a gamma value for a pixel of an input image based on a grayscale value of the pixel, the gamma value being varied depending on the grayscale value, and performing grayscale correction on the input image by raising the grayscale value of the pixel of the input image to a power of the gamma value, the grayscale value being normalized.

According to an embodiment of the present disclosure, a gamma value for a pixel of an input image may be calculated based on a grayscale value of the pixel, the gamma value being varied depending on the grayscale value, and grayscale correction on the input image may be performed by raising the grayscale value of the pixel of the input image to a power of the gamma value, the grayscale value being normalized.

According to an embodiment of the present technology, it is possible to present a high quality image in a simple way while preventing an increase in the amount of data.

### BRIEF DESCRIPTION OF THE DRAWINGS

FIG. 1 is a diagram illustrating whether or not the difference from one grayscale to another of an image is discriminated;

FIG. 2 is a diagram illustrating gamma characteristics;

FIG. 3 is a diagram illustrating an example of the combination of maximum luminance, minimum value of a gamma value, and maximum value of the gamma value;

FIG. 4 is a diagram illustrating an exemplary configuration of the image processing device;

FIG. 5 is a flowchart illustrating a grayscale correction process; and

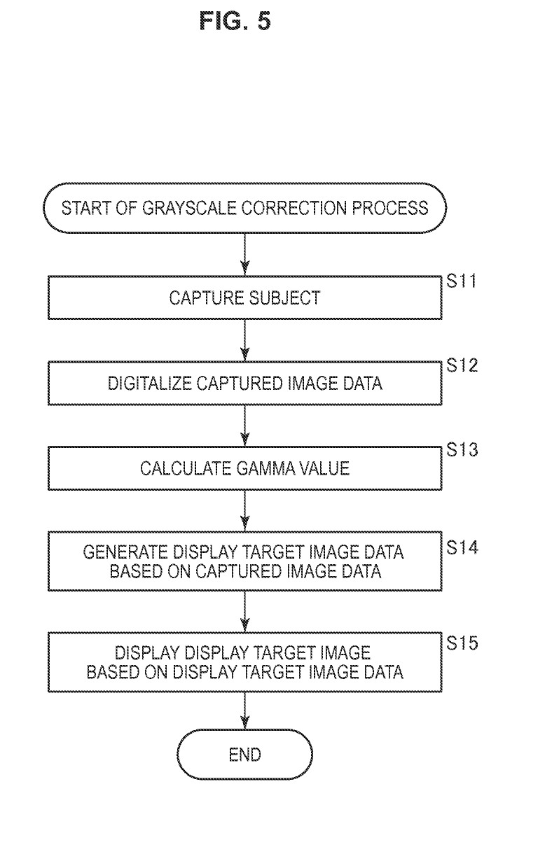

FIG. 6 is a diagram illustrating an exemplary configuration of the computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### First Embodiment

[Generation of Stereoscopic Images]

The present technology is intended to present a high quality image while minimizing the increase in the data amount of image data, for example, by assigning an appropriate bit length instead of currently insufficient bit length with respect to grayscale of an image in household video devices and by setting a gamma value γ to a variable value.

An overview of the present technology will be now described.

There has been known a BMT (Barten Modulation Threshold) model as a model with high reliability which has been obtained from the study on contrast sensitivity of the human eye (for example, refer to P. J. Barten, “Contrast Sensitivity of the HUMAN EYE and Its Effects on Image Quality”, SPIE Optical Engineering Press, 1999).

This BMT model is a model which describes the contrast threshold. In addition, there has been known that the BMT model has more strict conditions than in a collocation method in which the displays with different luminance are presented to be adjacent to each other, and the BMT model matches well with the test result in a flicker photometry having high sensitivity in which the displays with different luminance are presented alternately in time.

In the BMT model, a BMT value which is a contrast threshold value is given by a reciprocal of the contrast sensitivity function S(u).

In addition, in a case of using stimulus for spatially varying the luminance in a sinusoidal waveform, the contrast threshold value refers to a value of the minimum contrast at which the stimulus can be detected. Further, the contrast sensitivity function S(u) is an index indicating the spatial characteristics of the visual sense, and is a function expressed by the following Equation 1.

$$S ( u ) = \frac{{M}_{opt} ( u ) / k}{\sqrt{\frac{2}{T} ( \frac{1}{{X}_{0}^{2}} + \frac{1}{{X}_{ma x}^{2}} + \frac{{u}^{2}}{{N}_{m ax}^{2}} ) ( \frac{1}{η pE} + \frac{{φ}_{0}}{1 - {e}^{- {( u / {u}_{0} )}^{2}}} )}} \qquad ( 1 )$$

Here, in Equation 1, u represents a spatial frequency, k represents an S/N ratio, T represents an integral time of the eye, X₀ represents the size of a target image, and Xₘₐₓ represents the maximum value of viewing angle which can be integrated by the eye. In addition, Nₘₐₓ represents the maximum spatial frequency which can be integrated by the eye, η represents quantum efficiency of the eye, p represents a conversion factor of the photon, φ₀ represents a spectral density of neural noise, and u₀ represents the maximum spatial frequency on which lateral inhibition acts.

In addition, in Equation 1, M_{OPT}(u) is an optical MTF (Modulation Transfer Function) shown in the following Equation 2.

Mₒₚₜ(u)=e^{-2π}^{²}^{τ}^{²}^{u}^{²} (2)

Here, σ in Equation 2 is a value shown in the following Equation 3, and, in Equation 3, σ₀ is a constant value, C_{ab} represents a spherical aberration of the eye lens, and d represents the diameter of the pupil.

σ=\sqrt{σ₀²+(C_{ab}d)²} (3)

In addition, d in Equation 3 varies depending on the luminance L, as shown in the following Equation 4.

d=5−3 tan h(0.4 log LX₀²/40²) (4)

Further, in Equation 1, E represents the retinal illuminance shown in the following Equation 5.

$$E = \frac{π {d}^{2}}{4} L \qquad ( 5 )$$

In addition, the respective representative values of parameters of the contrast sensitivity function S(u) shown in Equation 1 are as follows. In other words, k=3, T=0.1 sec, η=0.03, σ₀=0.0083 arc deg, Xₘₐₓ=12°, φ₀=3×10⁻⁸ sec deg², C_{ab}=0.0013 arc deg/mm, Nₘₐₓ=15 cycles, u₀=7 cycles/deg, X₀=4°, p=1.285 photons/sec/deg²/td.

By using the BMT, that is, a contrast threshold value which is a reciprocal of the contrast sensitivity function S(u) defined in the above-described way, it can be found whether an image after a grayscale correction is performed using a gamma value γ is an image having sufficient visual characteristics. In other words, it can be found whether a user who observes an image can discriminate the difference in luminance from one grayscale to another in a pixel of the image.

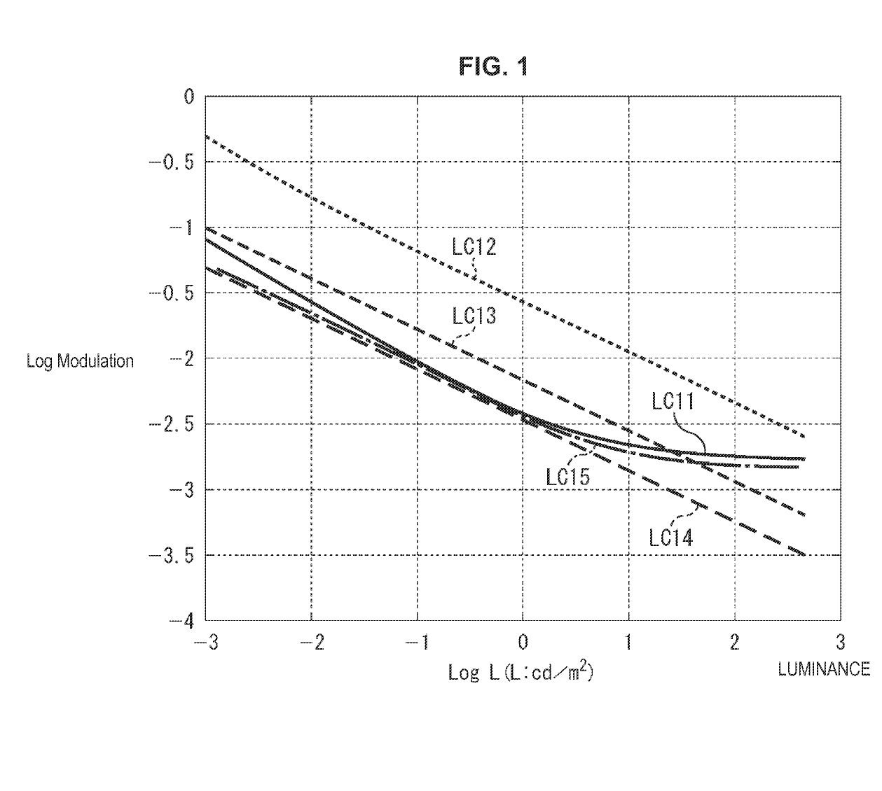

Specifically, for example, as shown in FIG. 1, in the graph in which the vertical axis represents reciprocals of contrast and the horizontal axis represents luminance values, a curve indicating the reciprocal of contrast at each luminance value when a gamma value γ for grayscale correction is set to a predetermined value is preferably located on a lower side in the figure than the curve indicating the BMT.

In the example shown in FIG. 1, the curve LC11 represents the BMT, and the curves LC12 to LC15 represent reciprocals of contrast at the respective luminance values when an image is subjected to grayscale correction in the respective conditions. For example, an image to be subjected to a grayscale correction is referred to as a captured image, and an image obtained through the grayscale correction of the captured image is referred to as a display target image (image to be displayed). In addition, it is assumed that the maximum luminance when displaying a display target image is 450 cd/m².

In this case, if a gamma value γ used for the grayscale correction is 2.6 and a 10-bit depth grayscale per pixel is used in a display target image, that is, a pixel value of the pixel is a value expressed by 10 bits, then the reciprocals of contrast for the respective luminance values of the display target image are indicated by the curve LC12. Since the curve LC12 is located on the upper side in the figure than the curve LC11 indicating the BMT in the overall luminance range, the difference from one grayscale to another in a pixel is discriminated by a user in the display target image which is obtained through the grayscale correction in this condition. For this reason, it is difficult to regard that the display target image is an image with adequate quality.

In addition, the curve LC13 represents reciprocals of contrast for the respective luminance values of a display target image in a case where a gamma value γ used for grayscale correction is 2.6 and a 12-bit depth grayscale per pixel is used in the display target image. The curve LC13 is located on the upper side in the figure than the curve LC11 indicating the BMT in the region from the low luminance to the intermediate luminance, but is located on the lower side in the figure than the curve LC11 in the high luminance region. Thus, it can be seen that there is a margin for the visual characteristics in the high luminance region.

In addition, the curve LC14 represents reciprocals of contrast for the respective luminance values of a display target image in a case where a gamma value γ used for grayscale correction is 2.6 and a 13-bit depth grayscale per pixel is used in the display target image. Since this curve LC14 is located on the lower side in the figure than the curve LC11 indicating the BMT in the overall luminance range, the difference from one grayscale to another in a pixel is not discriminated by a user in the display target image obtained through the grayscale correction in this condition. That is to say, it is possible that the display target image is an image with adequate quality.

As above, in a case where the gamma value γ is fixed to 2.6 and a bit depth of grayscale increases, if the bit depth is set to 13 bits, then the difference from one grayscale to another in a display target image is not discriminated by a user. However, if a bit depth of grayscale of the display target image is set to 13 bits, a data amount of image data (hereinafter, referred to as display target image data) of the display target image increases. From the viewpoint of mounting in a display device or in consideration of a data amount of display target image data, a bit depth of grayscale of a display target image is preferably in the order of 12 bits.

Therefore, in the present technology, attention is paid to there being a margin for the visual characteristics since the curve LC13 is located on the lower side than the curve LC11 in the high luminance region, and a gamma value γ for grayscale correction is varied with respect to a pixel value (hereinafter, also referred to as a grayscale value CV) of a captured image. This makes it possible to reduce reasonably a data amount of display target image data while maintaining the quality of a display target image to be high in a high luminance condition.

For example, when a gamma value γ used for grayscale correction is varied to any one of 3.0 to 6.0 depending on a grayscale value CV and a 12-bit depth grayscale per pixel is used in a display target image by applying the embodiment of the present technology, reciprocals of contrast for luminance values of the display target image are represented by the curve LC15. Since this curve LC15 is located on the lower side in the figure than the curve LC11 indicating the BMT in the overall luminance range, a user does not discriminate difference from one grayscale to another of a pixel in the display target image obtained through a grayscale correction in this condition. Thus, an image with adequate quality can be obtained.

More specifically, if the minimum value and maximum value of the gamma value γ varied with respect to a pixel value (a grayscale value CV) of a pixel of a captured image are indicated by a gamma value γₘᵢₙ and a gamma value γₘₐₓ, respectively, then the gamma value γ for each grayscale value CV is given as in the following Equation 6.

γ=γₘᵢₙ+{CV/(2ⁿ−1)}×(γₘₐₓ−γₘᵢₙ) (6)

In addition, in Equation 6, n represents a bit depth of grayscale per pixel of a display target image, that is, the number of bits of digital grayscale. Therefore, for example, in the example of the curve LC15, n=12, γₘₘ=3.0, and γₘₐₓ=6.0. In this case, a gamma value γ increases from 3.0 to 6.0 in proportion to a grayscale value CV as the grayscale value CV increases.

In addition, if a pixel value of a pixel of a display target image which is intended to be obtained through grayscale correction of a captured image, that is, a pixel value corresponding to display luminance of a display unit is represented by L, and the maximum value of the pixel value L is represented by Max_L, then the pixel value L is a value expressed by the following Equation 7.

L=Max_{—}L×(CV/(2ⁿ−1))^{γ} (7)

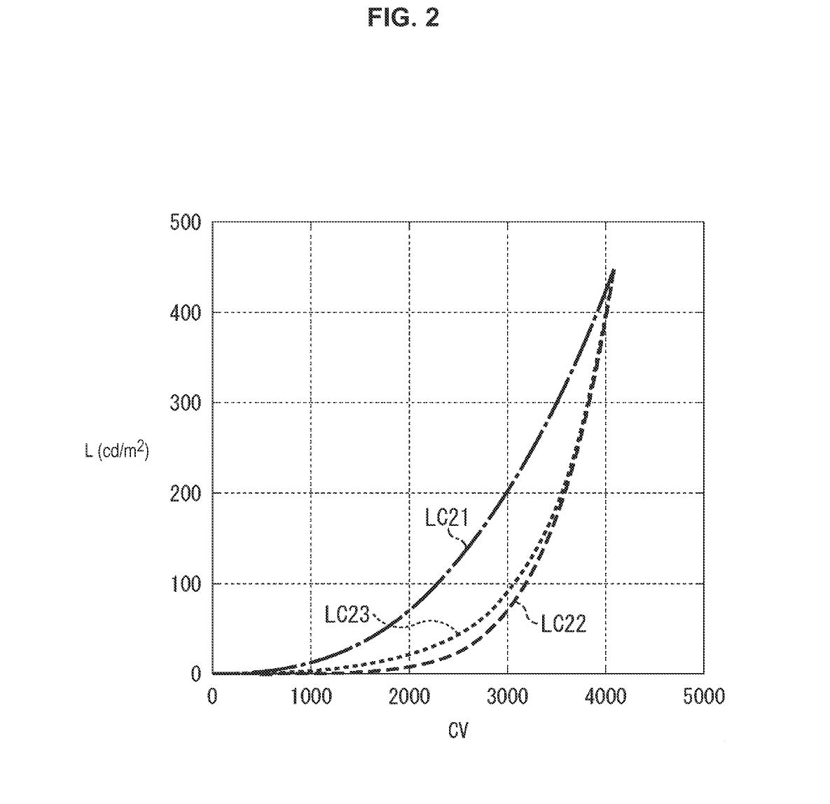

In a case where such a grayscale correction is performed, characteristics of the gamma value γ, that is, gamma curves are shown in FIG. 2. In addition, in FIG. 2, the vertical axis represents luminance values of a display target image, that is, luminance values of pixels displayed by the pixel value L, and the horizontal axis represents pixel values (grayscale values CV) of pixels of a captured image. Further, in the example of FIG. 2, the maximum luminance of the display target image is 450 cd/m².

In FIG. 2, the curve LC21 indicates display luminance values of a display target image with respect to the respective grayscale values CV when the gamma value γ is fixed to 2.6, and LC22 indicates display luminance values of a display target image with respect to the respective grayscale values CV when the gamma value γ is fixed to 6.0. When the curve LC21 and the curve LC22 are compared with each other, variation in the display luminance of the display target image with respect to variation in the grayscale value CV is smaller in the curve LC22 than in the curve LC21 in the region where the grayscale value CV is small.

In addition, the curve LC23 indicates display luminance values of a display target image with respect to the respective grayscale values CV when the gamma value γ is set to the gamma value γₘᵢₙ=3.0 and the gamma value γₘₐₓ=6.0 according to Equation (6). In a case of the curve LC23 as well, it can be seen that variation in the display luminance of the display target image with respect to variation in the grayscale value CV is smaller than in the curve LC21 in the region where the grayscale value CV is small.

As described above, since the discrimination threshold of the human eye at the low luminance is small, variation in the display luminance of the display target image with respect to variation in the grayscale value CV is preferably small in a region where the luminance is low.

Therefore, in the embodiment of the present technology, the gamma value γ is set according to Equation 6, thus variation in the display luminance of the display target image with respect to variation in the grayscale value CV is made to be small in the low luminance region. As a result, a high quality display target image can be presented in a simple way while preventing an increase in the amount of data. In other words, according to Equation 6, the smaller the grayscale value CV, the smaller the gamma value γ. Therefore, when grayscale correction shown in Equation 7 is performed, the smaller the grayscale value CV, the smaller the variation in a pixel value L of the display target image with respect to the variation in the grayscale value CV.

As described above, since the gamma value γ varies depending on a grayscale value CV, that is, the gamma value γ is proportionally distributed depending on the grayscale value CV, it is possible to obtain a high quality display target image having a smaller amount of data through a simple calculation using Equation 6 or 7.

Particularly, the gamma value γ of Equation 6 is maintained not as a lookup table or the like but as a function, and thus a display target image can be obtained more simply by performing computation at every such time. This is because, for example, if the gamma value γ is defined by a lookup table or the like, a configuration or a process becomes complicated, and thus a disadvantage tends to occur in sending and receiving signals correctly and easily between systems.

In addition, according to Equation 6, it is possible to realize gamma characteristics suitable for the visual characteristics through a simple calculation using only the four arithmetic operations (product-sum operation). That is to say, in Equation 6, a complex calculation such as exponent or logarithm which increases computational costs is not substantially performed, and thus it is possible to rapidly obtain the gamma value γ through a simple calculation.

In addition, in the above description, a case where the maximum luminance corresponding to the maximum value Max_L of a pixel value L of a pixel of a display target image is 450 cd/m², and the gamma value γₘᵢₙ=3.0 and the gamma value γₘₐₓ=6.0 has been described as an example. However, as long as a display target image with adequate quality can be obtained, any combination of the maximum luminance, gamma value γₘᵢₙ and gamma value γ may be employed.

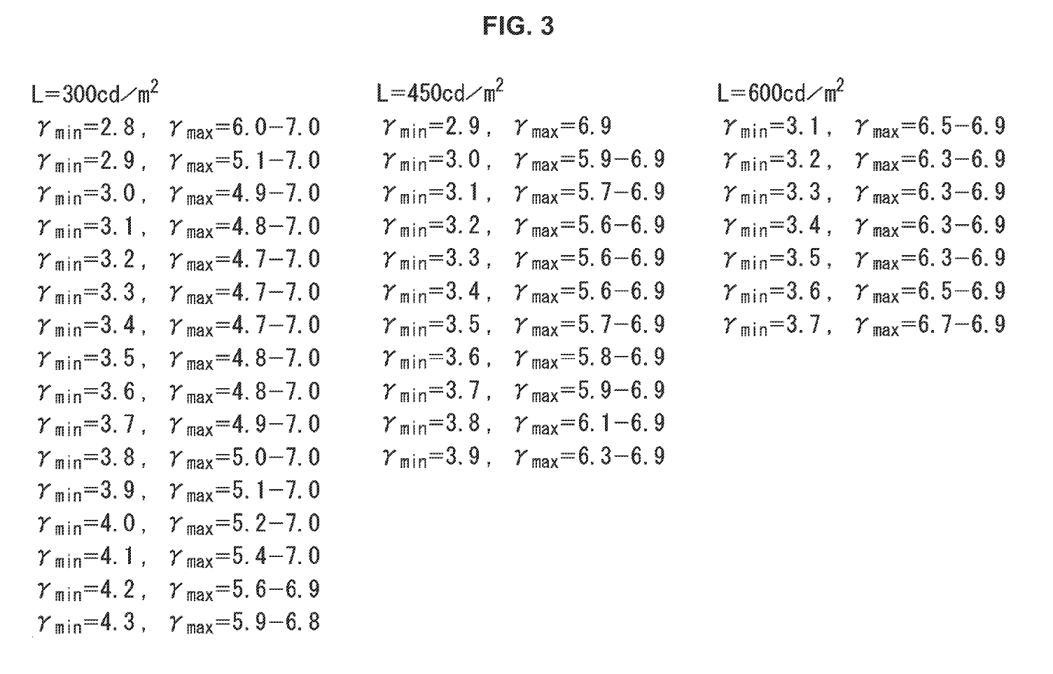

For example, at all luminance values which are less than or equal to the maximum luminance of a display target image, combinations of the maximum luminance, gamma value γₘᵢₙ and gamma value γₘₐₓ in which the luminance difference from one grayscale to another in a pixel value of a pixel of the display target image may not be discriminated by the human eye are shown in FIG. 3.

In other words, at all luminance values of a display target image, combinations of the maximum luminance, gamma value γₘᵢₙ, and gamma value γₘₐₓ in which reciprocals of contrast are smaller than the BMT indicated by the curve LC11 of FIG. 1 may employ the combinations shown in FIG. 3, for example. In addition, in the example shown in FIG. 3, a 12-bit depth grayscale per pixel is used in a display target image.

In FIG. 3, combinations of a gamma value γₘᵢₙ and a gamma value γₘₐₓ are shown in the left part of the figure in a case where the maximum luminance of a display target image is 300 cd/m².

For example, in the example shown on the uppermost column of the left part in the figure, a gamma value γₘₐₓ is any value of 6.0 to 7.0 for a gamma value γₘᵢₙ=2.8. The left part of the figure shows gamma values γₘₐₓ for the respective values of gamma values γₘᵢₙ of 2.8 to 4.3. In this case, a value of the gamma value γₘₐₓ is any value between 4.7 and 7.0.

In addition, combinations of a gamma value γₘᵢₙ and a gamma value γₘₐₓ are shown in the middle part of the figure in a case where the maximum luminance of a display target image is 450 cd/m².

For example, in the example shown on the uppermost column of the middle part in the figure, a gamma value γₘₐₓ is 6.9 for a gamma value γₘᵢₙ=2.9. The middle part of the figure shows gamma values γₘₐₓ for the respective values of gamma values γₘᵢₙ of 2.9 to 3.9, and, in this case, a value of the gamma value γₘₐₓ is any value between 5.6 and 6.9.

In addition, combinations of a gamma value γₘᵢₙ and a gamma value γₘₐₓ are shown in the right part of the figure in a case where the maximum luminance of a display target image is 600 cd/m².

For example, in the example shown on the uppermost column of the right part in the figure, a gamma value γₘₐₓ is any value of 6.5 to 6.9 for a gamma value γₘᵢₙ=3.1. The right part of the figure shows gamma values γₘₐₓ for the respective values of gamma values γₘᵢₙ of 3.1 to 3.7, and, in this case, a value of the gamma value γₘₐₓ is any value between 6.3 and 6.9.

### Configuration Example of Image Processing Device

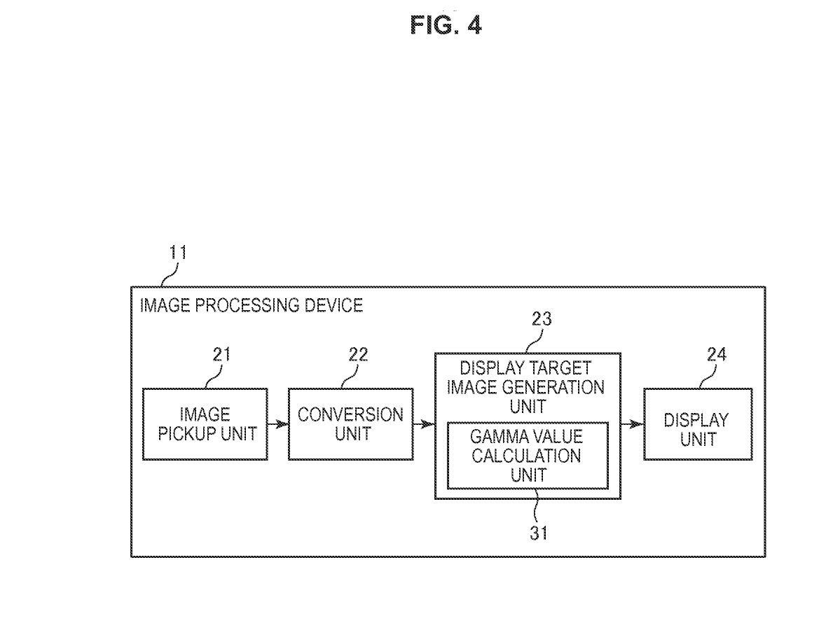

Next, a detailed embodiment to which the present technology is applied will be described. FIG. 4 is a diagram illustrating an exemplary configuration of an image processing device according to an embodiment of the present technology.

The image processing device 11 of FIG. 4 includes an image pickup unit 21, a conversion unit 22, a display target image generation unit 23, and a display unit 24.

The image pickup unit 21 is constituted by, for example, imaging elements, captures a subject, and supplies image data (hereinafter, also referred to as a captured image data) of a captured image obtained as a result thereof to the conversion unit 22. The conversion unit 22 digitalizes the captured image data supplied from the image pickup unit 21 and supplies the digitalized captured image data to the display target image generation unit 23.

The display target image generation unit 23 performs grayscale correction on the captured image data supplied from the conversion unit 22, and thus generates display target image data which is supplied to the display unit 24. In addition, the display target image generation unit 23 includes a gamma value calculation unit 31. The gamma value calculation unit 31 calculates a gamma value used to generate display target image data based on a grayscale value of a pixel of the captured image.

The display unit 24 may be a liquid crystal display and other devices. The display unit 24 displays a display target image based on the display target image data supplied from the display target image generation unit 23.

[Grayscale Correction Process]

Subsequently, a description will be made of a grayscale correction process performed by the image processing device 11.

In step S11, the image pickup unit 21 captures a subject in response to an instruction from a user who operates the image processing device 11, and supplies captured image data of a captured image obtained as a result thereof to the conversion unit 22.

In step S12, the conversion unit 22 digitalizes the captured image data supplied from the image pickup unit 21 and supplies the digitalized captured image data to the display target image generation unit 23.

For example, the conversion unit 22 sequentially selects each pixel of the captured image data as a target pixel, and obtains a grayscale value CV satisfying the following Equation 8 with respect to a pixel value q of the target pixel.

q=Max_{—}q×(CV/(2ⁿ−1)) (8)

The conversion unit 22 sets the obtained grayscale value CV as a pixel value of a pixel of the digitalized captured image which is located at the same position as the target pixel, thereby converting the captured image data which is an analog signal into a digital signal.

In addition, n in Equation 8 is a bit depth of a pixel of the digitalized captured image, and, a gamma value γ in Equation 8 is a value defined according to Equation 6 described above. Here, a gamma value γₘᵢₙ and a gamma value γₘₐₓ in Equation 6 are predefined values, and, the bit depth n assigned to Equation 6 in this case is a predefined bit depth of grayscale of a pixel of the captured image. Specifically, for example, the bit depth n is 12, the gamma value γₘᵢₙ is 3.0, and the gamma value γₘₐₓ is 6.0.

In addition, the conversion unit 22 may record a table in which a pixel value q of the captured image data before being digitalized is correlated with a pixel value (the grayscale value CV) of the captured image data after being digitalized corresponding to the pixel value q for each value of n, γₘᵢₙ and γₘₐₓ. In this case, the conversion unit 22 can simply digitalize the captured image data by referring to the recorded table.

In step S13, the gamma value calculation unit 31 calculates a gamma value γ based on the captured image data supplied from the conversion unit 22.

In other words, the gamma value calculation unit 31 sequentially selects each pixel of the captured image data as a target pixel, and obtains a gamma value γ for a grayscale value CV by assigning a pixel value of the target pixel, that is, the grayscale value CV to Equation 6.

Here, the bit depth n used for calculation of Equation 6 in step S13 is a bit depth of grayscale of a pixel of the display target image. For example, a n-bit depth grayscale, gamma value γₘᵢₙ, and gamma value γₘₐₓ used for the calculation of Equation 6 in step S13 employ the same values as the values used for the calculation of Equation 6 in the process of step S12.

In the calculation of Equation 6, the grayscale value CV is normalized using the bit depth of grayscale, and the normalized grayscale value CV is multiplied by a difference between the maximum value and the minimum value of a gamma value. In addition, the minimum value of the gamma value is added to a value obtained as a result thereof, and a resultant value is set as a gamma value γ for the grayscale value CV of the target pixel.

In step S14, the display target image generation unit 23 generates display target image data based on both the captured image data supplied from the conversion unit 22 and the gamma value γ calculated by the gamma value calculation unit 31, and supplies the display target image data to the display unit 24.

For example, the display target image generation unit 23 assigns the gamma value γ and the grayscale value CV to Equation 7, and sets a pixel value L obtained as a result thereof as a pixel value of a pixel of the display target image which is located at the same position as the target pixel of the captured image. In other words, the display target image generation unit 23 raises the grayscale value CV which is normalized using the bit depth of grayscale of the display target image to the power of the gamma value γ, multiplies a value obtained as a result thereof by the maximum value Max_L, and thus a pixel value L of the pixel of the display target image is calculated. This makes it possible to obtain display target image data of the display target image.

In addition, in imaging and displaying a subject, that is, in the processes in steps S12 and S14, equations such as Equations 7 and 8 are used to make grayscale characteristics similar.

In addition, in the process in step S14, the display target image generation unit 23 may record a table in which a grayscale value CV of a captured image is correlated with a pixel value L of display target image data corresponding to the grayscale value CV for each value of n, γₘᵢₙ, and γₘₐₓ. In this case, the display target image generation unit 23 converts a grayscale value CV of a captured image into a pixel value L by referring to the recorded table, and generates a display target image.

In step S15, the display unit 24 displays a display target image based on the display target image data supplied from the display target image generation unit 23, and the grayscale correction process finishes. In other words, the display unit 24 emits, from each pixel in a display region, light with the luminance defined by the pixel value L of a pixel of the display target image data corresponding to these pixels of the display region, thereby displaying a display target image. In addition, the display target image data generated by the display target image generation unit 23 may be recorded on a recording medium (not shown).

In the above-described way, the image processing device 11 performs grayscale correction on the captured image data by using a gamma value γ corresponding to a grayscale value CV, thereby converting the captured image data into display target image data. As a result, it is possible to present a high quality display target image in a simple way while preventing an increase in the amount of data.

Further, although, in the above description, a description has been made that the image pickup unit 21 or the conversion unit 22 is provided inside the image processing device 11, the image pickup unit 21 or the conversion unit 22 may be provided outside the image processing device 11. Similarly, the display unit 24 may also be provided outside the image processing device 11.

Meanwhile, the above-described series of processes may be performed by hardware or software. When the series of processes is performed by the software, programs constituting the software are installed in a computer. Here, the computer includes a computer incorporated into dedicated hardware, or, for example, a general purpose personal computer or the like which can execute various functions by installing various kinds of programs.

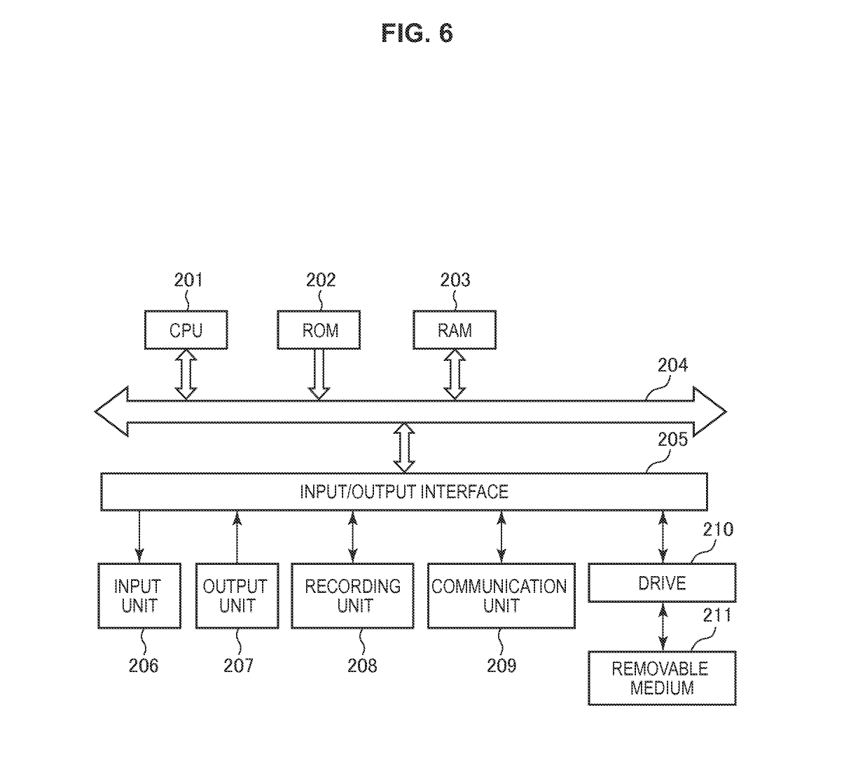

FIG. 6 is a block diagram illustrating a hardware configuration example of a computer which executes the series of processes using a program.

In the computer, a CPU (Central Processing Unit) 201, a ROM (Read Only Memory) 202, and a RAM (Random Access Memory) 203 are connected to each other via a bus 204.

An input/output interface 205 is further connected to the bus 204. The input/output interface 205 is connected to an input unit 206, an output unit 207, a recording unit 208, a communication unit 209, and a drive 210.

The input unit 206 may include a keyboard, a mouse, a microphone, an imaging element, or the like. The output unit 207 may include a display, a speaker, and the like. The recording unit 208 may include a hard disk, a nonvolatile memory, or the like. The communication unit 209 may include a network interface or the like. The drive 210 drives a removable medium 211 such as a magnetic disk, an optical disc, a magneto-optical disc, or a semiconductor memory.

In the computer with the above-described configuration, the CPU 201 loads a program recorded in, for example, the recording unit 208 to the RAM 203 via the input/output interface 205 and the bus 204 and executes the program, thereby performing the above-described series of processes.

The program executed by the computer (the CPU 201) may be recorded, for example, on the removable medium 211 which is a package medium. In addition, the program may be provided via wired or wireless transmission media such as a local area network, the Internet, and digital satellite broadcasting.

In the computer, when the removable medium 211 is mounted on the drive 210, the program may be installed to the recording unit 208 via the input/output interface 205. In addition, the program may be received by the communication unit 209 via a wired or wireless transmission media and may be installed to the recording unit 208. Further, the program may be installed to the ROM 202 or the recording unit 208 in advance.

The program executed by the computer may be a program for executing the processes on a time-sequential basis in the order described herein. Alternatively, it may be a program for executing the processes in parallel or at timing when the process is necessary, e.g., when a process call is made.

It should be understood by those skilled in the art that various modifications, combinations, sub-combinations and alterations may occur depending on design requirements and other factors insofar as they are within the scope of the appended claims or the equivalents thereof.

For example, the embodiments of the present technology may employ cloud computing in which a single function is distributed to a plurality of devices via a network and is processed in cooperation.

In addition, each step described in the above flowchart may be not only executed by a single device, but may also be distributed to a plurality of devices and be executed.

Further, in a case where a single step includes a plurality of processes, the plurality of processes included in the step may be not only executed by a single device, but may also be distributed to a plurality of devices and be executed.

Additionally, the present technology may also be configured as below.

### (1) An Image Processing Device Including:

a gamma value calculation unit that calculates a gamma value for a pixel of an input image based on a grayscale value of the pixel, the gamma value being varied depending on the grayscale value; and

an image generation unit that performs grayscale correction on the input image by raising the grayscale value of the pixel of the input image to a power of the gamma value, the grayscale value being normalized.

(2) The image processing device according to (1), wherein the gamma value is varied from a first value to a second value in proportion to the grayscale value, the second value being greater than to the first value.
(3) The image processing device according to (2), wherein the gamma value calculation unit calculates the gamma value by calculating γₘᵢₙ+(CV/(2ⁿ−1))×(γₘₐₓ−γₘᵢₙ), where n represents a grayscale bit depth of the pixel of the input image after the grayscale correction is performed, CV represents the grayscale value of the pixel, γₘᵢₙ represents the first value, and γₘₐₓ represents the second value.
(4) The image processing device according to (3), wherein, when the bit depth n is 12, the first value γₘᵢₙ is any value between 2.8 and 4.3, and the second value γₘₐₓ is any value between 4.7 and 7.0.
(5) The image processing device according to (4), wherein the image generation unit calculates a pixel value of the pixel of the input image after the grayscale correction is performed by calculating Max_Lx(CV/(2ⁿ−1))^{γ}, where Max_L represents a maximum value of the pixel value of the pixel of the input image after the grayscale correction is performed, and γ represents the gamma value.

The present disclosure contains subject matter related to that disclosed in Japanese Priority Patent Application JP 2012-045469 filed in the Japan Patent Office on Mar. 1, 2012, the entire content of which is hereby incorporated by reference.

What is claimed is:

1. An image processing device comprising:
a gamma value calculation unit that calculates a gamma value for a pixel of an input image based on a grayscale value of the pixel, the gamma value being varied depending on the grayscale value; and
an image generation unit that performs grayscale correction on the input image by raising the grayscale value of the pixel of the input image to a power of the gamma value, the grayscale value being normalized.

2. The image processing device according to claim 1, wherein the gamma value is varied from a first value to a second value in proportion to the grayscale value, the second value being greater than to the first value.

3. The image processing device according to claim 2, wherein the gamma value calculation unit calculates the gamma value by calculating γₘᵢₙ+(CV/(2ⁿ−1))×(γₘₐₓ−γₘᵢₙ), where n represents a grayscale bit depth of the pixel of the input image after the grayscale correction is performed, CV represents the grayscale value of the pixel, γₘᵢₙ represents the first value, and γₘₐₓ represents the second value.

4. The image processing device according to claim 3, wherein, when the bit depth n is 12, the first value γₘᵢₙ is any value between 2.8 and 4.3, and the second value γₘₐₓ is any value between 4.7 and 7.0.

5. The image processing device according to claim 4, wherein the image generation unit calculates a pixel value of the pixel of the input image after the grayscale correction is performed by calculating Max_L×(CV/(2ⁿ−1))^{γ}, where Max_L represents a maximum value of the pixel value of the pixel of the input image after the grayscale correction is performed, and γ represents the gamma value.

6. An image processing method comprising:
calculating a gamma value for a pixel of an input image based on a grayscale value of the pixel, the gamma value being varied depending on the grayscale value; and
performing grayscale correction on the input image by raising the grayscale value of the pixel of the input image to a power of the gamma value, the grayscale value being normalized.

7. A program for causing a computer to execute the processes of:
calculating a gamma value for a pixel of an input image based on a grayscale value of the pixel, the gamma value being varied depending on the grayscale value; and
performing grayscale correction on the input image by raising the grayscale value of the pixel of the input image to a power of the gamma value, the grayscale value being normalized.
